(19) United States
(12) Patent Application Publication
(10) Pub. No.: US 2017/0355052 A1
(43) Pub. Date: Dec. 14, 2017

(54) HANDLING APPARATUS FOR USE AT A MACHINE TOOL

(71) Applicant: GILDEMEISTER DREHMASCHINEN Gmbh, Bielefeld (DE)

(72) Inventor: Benjamin KORMANN, Mindelheim (DE)

(73) Assignee: GILDEMEISTER DREHMASCHINEN Gmbh, Bielefeld (DE)

(21) Appl. No.: 15/622,533

(22) Filed: Jun. 14, 2017

(30) Foreign Application Priority Data
Jun. 14, 2016 (DE) 10 2016 210 508.6

(51) Int. Cl. B23Q 7/04; B23Q 11/00; G05B 19/418; B23Q 3/155; B23Q 2003/155

(52) U.S. Cl. CPC B23Q 7/046; G05B 19/41815; B23Q 3/1554; B23Q 11/0082; B23Q 2003/155404

(57) ABSTRACT

The present invention relates to a handling apparatus 1 for use at a machine tool, comprising: a base body 2 which can be set up on a floor space, a storage body 3 which can be set up on the top side of the base body 2 and serves to store a plurality of workpieces or tools, and a handling robot 5, which is arranged on the base body 2 and has a gripper device 6 for receiving a workpiece and/or tool from the storage body 3 and for inserting the workpiece and/or tool taken from the storage body 3 by the gripper device 6 into a corresponding workpiece and/or tool support of the machine tool. A plurality of first set-up elements 18 are arranged on the bottom side of the storage body 3 and a plurality of first centering elements 19 are arranged on the top side of the base body 2, wherein, when the storage body 3 is set up on the top side of the base body 2, the first set-up elements 18 interact in each case in pairs and in self-centering manner with the first centering elements 19 in such a way that the storage body 3 adopts a predetermined reference position in relation to the base body 2.

The present invention relates to a handling apparatus for use at a machine tool, in particular a handling apparatus having a robot and/or robot arm for use at a machine tool, which is in particular designed for the automated insertion and/or exchange of workpieces and/or tools at a machine tool.

### BACKGROUND

The prior art discloses machine tools and in particular numerically controlled machine tools where workpieces can be machined by means of tools. Handling apparatuses for the automated insertion and/or exchange of workpieces and/or tools at the machine tool, e.g. by means of a program-controlled robot and/or robot arm, are known for the use at such machine tools.

DE 10 2009 048 863 A1 shows a generic exemplary handling apparatus for the automated insertion and/or exchange of workpieces and/or tools at a machine tool.

However, such handling apparatuses are usually fixed to the machine tool and/or adjacent to the machine tool and therefore use a space in the factory workshop next to the machine tool and cannot be used universally and efficiently.

On the basis of the prior art, an object of the invention is to provide a handling apparatus for use at a machine tool, which can be used universally and efficiently with a small space requirement and preferably in a mobile way at a plurality of machine tools, as needed, and which can be easily installed.

### SUMMARY OF THE INVENTION

In order to achieve the above mentioned objects, a handling apparatus according to claim 1 is proposed according to the invention. Dependent claims relate to preferred and exemplary embodiments of the invention.

The present invention proposes a handling apparatus for use at a machine tool, comprising a base body which can be set up on a floor space, a storage body which can be set up on the top side of the base body and serves to store a plurality of workpieces or tools, and a handling robot which is arranged on the base body and has a gripper device for taking a workpiece and/or tool from the storage body and for inserting the workpiece and/or tool taken from the storage body by the gripper device at a corresponding workpiece and/or tool support of the machine tool.

In useful embodiments, a plurality of first set-up elements are arranged on the bottom side of the storage body and a plurality of first centering elements are arranged on the top side of the base body, wherein, when the storage body is set up on the top side of the base body, the first set-up elements interact in each case in pairs and in self-centering manner with the first centering elements in such a way that the storage body adopts a predetermined reference position in relation to the base body.

The advantage is that the storage body can be easily introduced and exchanged and a manual loading of the workpieces and/or tools on the storage body does not have to be carried out on the handling apparatus. It is thus possible to carry out set-up times efficiently in parallel with the production times.

In addition, the storage body can easily be removed and also be readily attached again, the interaction between the centering and set-up elements rendering possible simple and accurate positioning and/or repositioning, which does not require the recalibration of a reference position.

In useful embodiments, three first set-up elements are arranged on the bottom side of the storage body, in particular preferably in order to provide a three-point setup. This renders possible in a favorable way a stable and accurate positioning in a predetermined plane.

In useful embodiments, three first centering elements are arranged on the top side of the base body, in particular preferably to provide a three-point setup. This renders possible in a favorable way a stable and accurate positioning in a predetermined plane.

In useful embodiments, preferably three first centering elements are preferably arranged on the top side of the base body in order to provide a three-point setup of the storage body in a first position, and three further first centering elements are preferably arranged on the top side of the base body in order to provide a three-point setup of the storage body in a second position. This favorably renders possible in a simple and efficient way two different storage body positions, which are always accurately positioned, as required.

In useful embodiments, the storage body has two receiving portions for fork arms of a fork-lift truck in order to receive and lift the storage body from the base body by means of a fork-lift truck. Due to this, a simple and efficient introduction and/or exchange of the storage body is favorably possible.

In useful embodiments, the storage body comprises a locking mechanism, preferably having a locking element, which can preferably be interlocked with a locking element arranged on the top side of the base body. Due to this, simple and efficient locking and/or unlocking of the storage body is favorably possible.

In useful embodiments, the locking mechanism is designed to unlock the locking element of the locking mechanism when fork arms of a fork-lift truck enter into the receiving portions of the storage body for fork arms. Due to this, simple and efficient locking and/or unlocking of the storage body is favorably possible.

In useful embodiments, the storage body carries a holding plate which has a plurality of receiving openings for tools and/or workpieces.

In useful embodiments, the handling robot has six controllable rotation axes and/or the gripper device of the handling robot has a double gripper.

In useful embodiments, a plurality of second set-up elements are arranged on the bottom side of the base body, which are designed to interact in each case in pairs and in self-centering manner with the second centering elements in the case of a base body set up on the floor space, when a plurality of second centering elements are arranged on the floor space, in such a way that the base body adopts a predetermined reference position in relation to the floor space and/or in relation to the machine tool placed on the floor space.

The advantage is that the handing apparatus can be used in succession in a simple and mobile way and universally at a plurality of machine tools.

In addition, the handling apparatus can be easily set up, the interaction of the centering and set-up elements rendering possible an easy and accurate positioning and/or repositioning step which does not require a recalibration of a reference position.

In useful embodiments, three second set-up elements are arranged on the bottom side of the base body in order to provide a three-point setup. Due to this, a stable and accurate positioning in a predetermined plane is favorably possible.

In useful embodiments, the handling apparatus comprises a sensor device for detecting a person (e.g. an operator) or an object (e.g. a fork-lift truck or an indoor crane) in an area adjacent to the handling apparatus. Due to this, a better safety can favorably be achieved.

In useful embodiments, the handling apparatus is designed to stop the operation when the sensor device detects a person or an object in a first area, and/or the handling apparatus is designed to switch to a decelerated operation when the sensor device detects a person or an object in a second area. Due to this, a better safety can favorably be achieved.

In useful embodiments, the handling apparatus can be connected and/or coupled to the machine tool and/or a control device of the machine tool via a wireless connection or cable plug connection.

In useful embodiments, the handling apparatus is designed to identify the coupled or connected machine tool among a group of (e.g. previously known) machine tools via the communication connection. Here, the handling apparatus can preferably be designed to determine a previously stored reference position depending on the identified machine tool. Due to this, simple and accurate positioning and/or repositioning, which does not require the recalibration of a reference position, is favorably possible.

In useful embodiments, the handling apparatus is designed to be controlled and/or installed via a control panel of the connected machine tool. Due to this, a simple uniform control of the machine tool and the handling apparatus is favorably possible without having to provide an independent control device of the handling apparatus.

Further aspects and the advantages thereof as well as advantages and more specific implementation options of the above described aspects and features are described in the below descriptions and explanations on the appending figures, which should, however, by no means regarded as limiting.

### BRIEF DESCRIPTION OF THE DRAWINGS

FIG. 1 shows an exemplary perspective view of a handling apparatus according to an embodiment of the invention;

FIGS. 2A to 2F show by way of example a front view, a right-hand side view, a left-hand side view, a rear view, a top view and a bottom view, respectively, onto a handling apparatus according to FIG. 1;

FIG. 3 shows by way of example a template for positioning centering elements for setting up the handling apparatus according to FIG. 1;

FIGS. 4A and 4B both show exemplary views of a pair of centering and set-up elements for setting up the handling apparatus according to FIG. 1;

FIGS. 5A and 5B both show exemplary views of the storage body of the handling apparatus according to FIG. 1;

FIG. 6 shows an exemplary perspective view of the handling apparatus according to FIG. 1, wherein the storage body is removed; and

FIG. 7 shows an exemplary top view of the handling apparatus according to FIG. 1 at a machine tool.

### DETAILED DESCRIPTION OF THE DRAWINGS AND PREFERRED EMBODIMENTS

Examples and embodiments of the present invention are described in detail below with reference to the appending drawings. Equal and/or similar elements in the drawings can here be designated by equal reference signs and sometimes also by different reference signs.

However, it should be noted that the present invention is by no means limited or restricted to the below described embodiments and the implementation features thereof but comprises further modifications of the embodiments, in particular those that are comprised by modifications of the features of the described examples and/or by combination of one or more features of the described examples on the basis of the scope of protection of the independent claims.

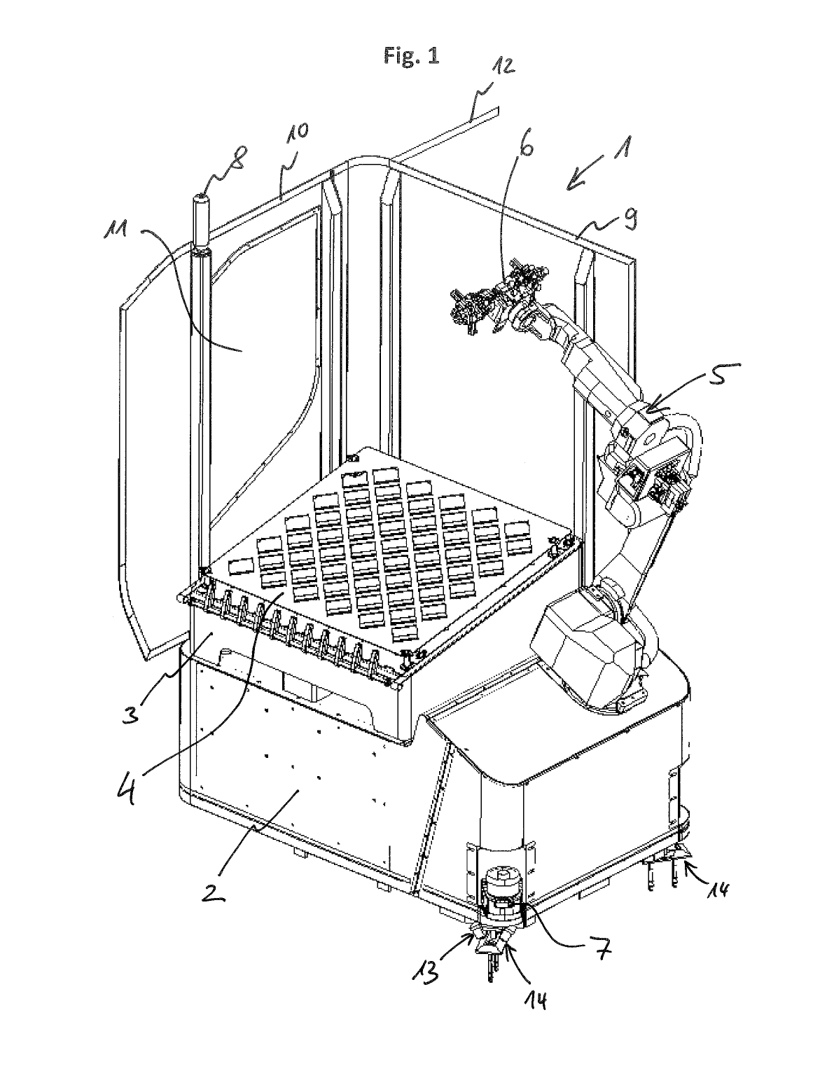

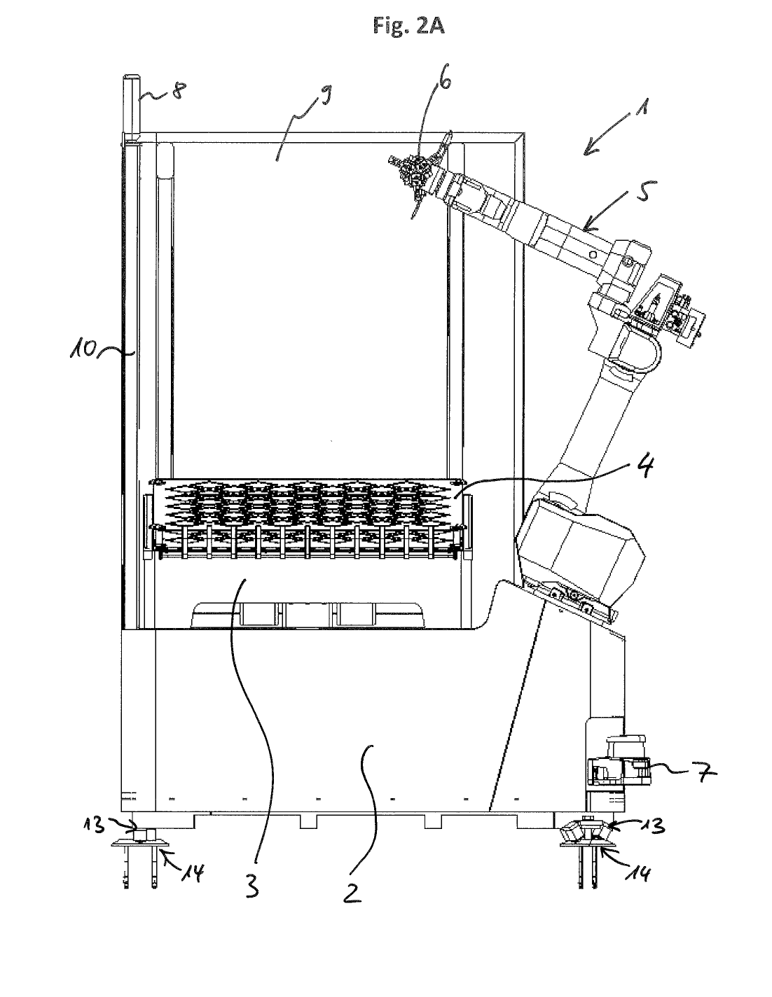

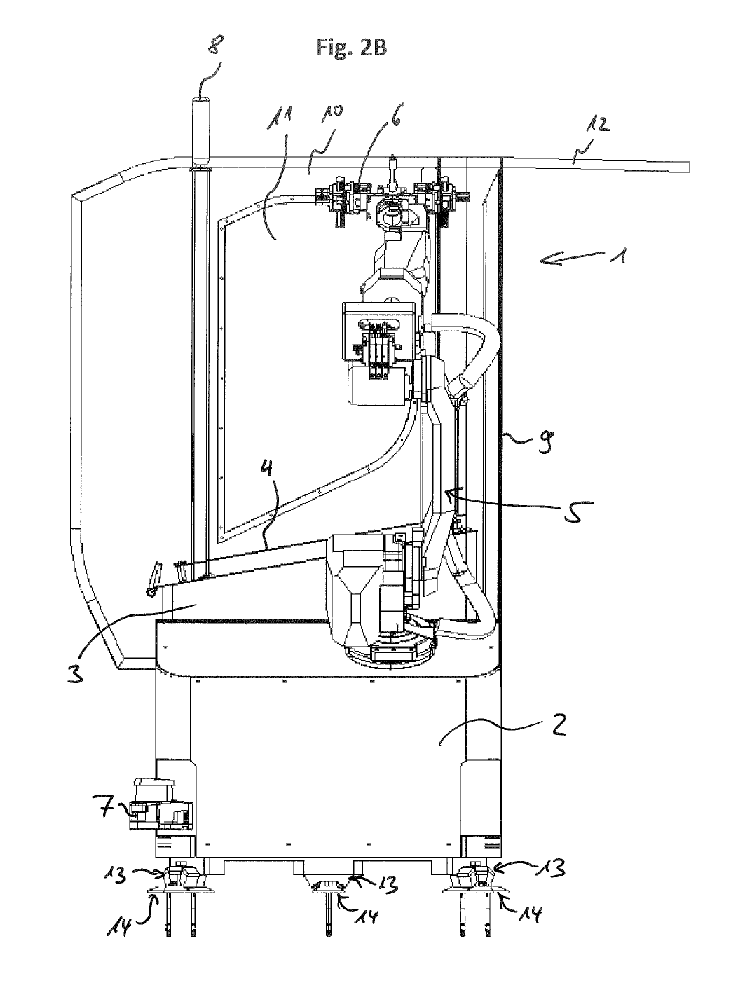

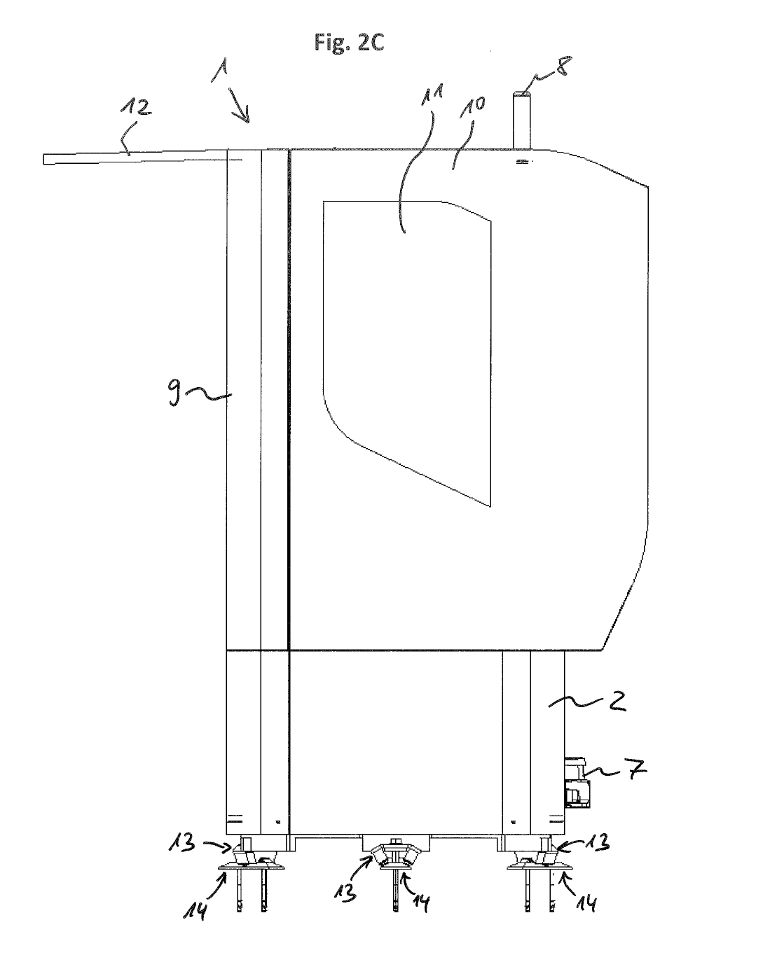

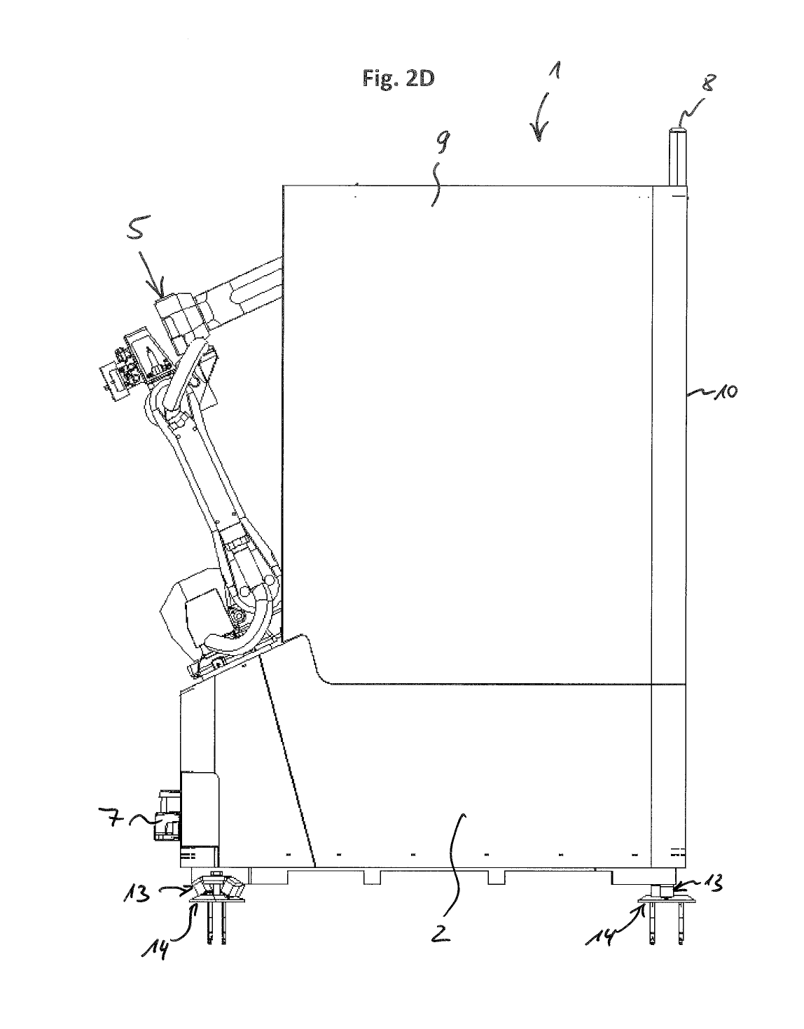

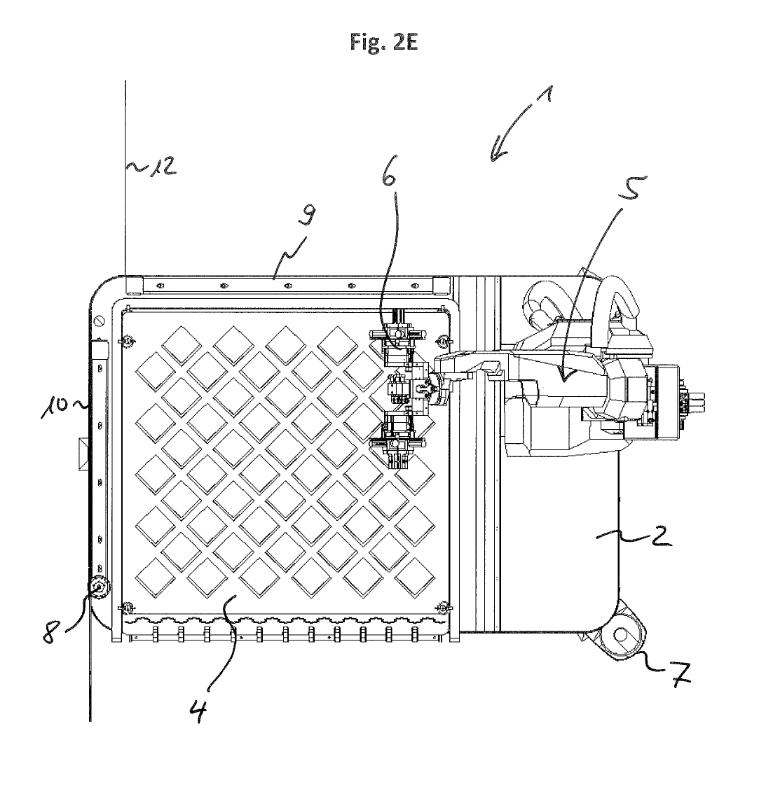

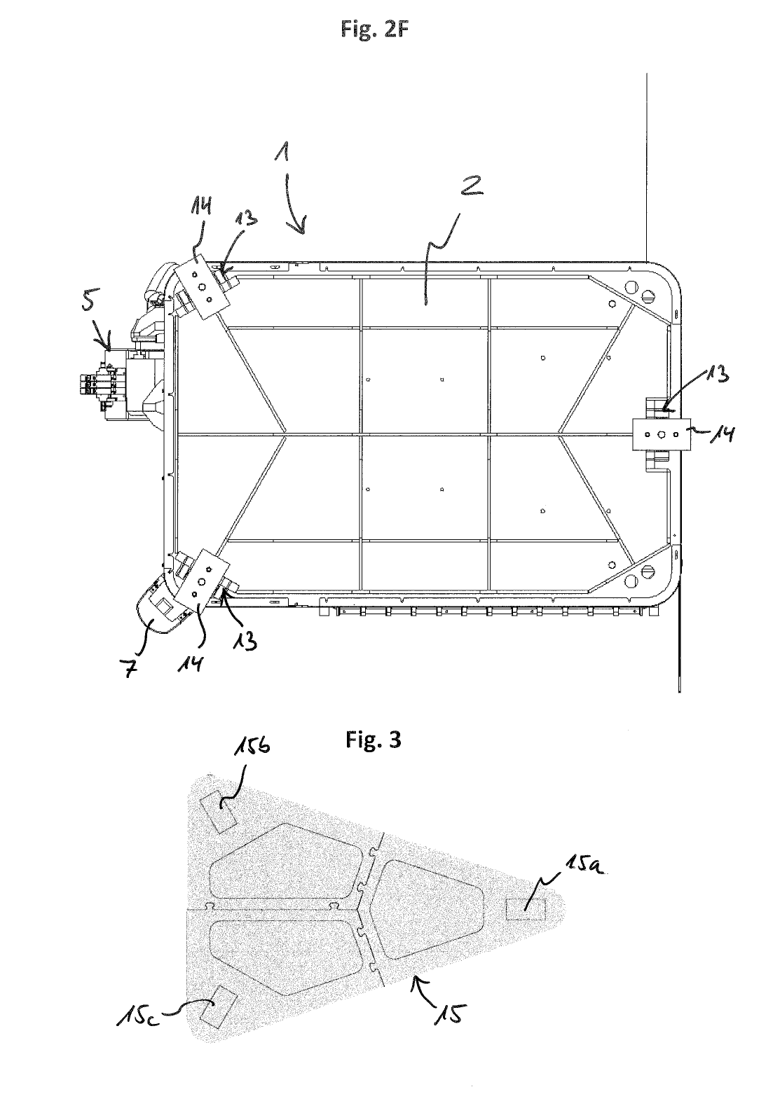

FIG. 1 shows an exemplary perspective view of a handling apparatus according to an embodiment of the invention. FIGS. 2A to 2F show by way of example a front view, a right-hand side view, a left-hand side view, a rear view, a top view and a bottom view, respectively, of the handling apparatus according to FIG. 1.

The handling apparatus 1 comprises a base body 2, which can be set up on a floor space e.g. of a factory workshop and in particular adjacent to or in front of a machine tool. A storage body 3 is arranged on the base body 2 and holds e.g. a workpiece holder plate. In preferred embodiments, the workpiece holder plate 4 can be placed on or detachably fastened to the storage body 3.

The workpiece holder plate 4 has e.g. a plurality of openings and/or tool supports which can hold and/or support respective workpieces that are to be machined or were machined on the machine tool. Alternatively or additionally, it is also possible to provide the openings and/or supports of the workpiece holder plate 4 with tools.

A robot 5 and/or a robot arm is arranged on the base body 2 laterally to the workpiece holder plate 4 and/or next to the storage body 3 and has a gripper device 6 for receiving workpieces and/or tools from the workpiece holder plate 4.

In this embodiment, the gripper device 6 is made e.g. as a double gripper, as a result of which the robot 6 can simultaneously hold and handle two workpieces or tools by means of the gripper device 6, in particular e.g. to take a workpiece or tool to be conveyed to the machine tool from the workpiece holder plate 4 by means of a gripper while another workpiece or tool removed from the machine tool is held by the other gripper and can then be inserted in the vacant spot of the workpiece holder plate 4.

The robot 5 is designed to insert workpieces and/or tools in automated fashion into the machine tool and/or remove them therefrom. For example, the robot 5 is made in this embodiment with six controllable and/or drivable rotation axes. However, it is also possible to provide a robot and/or robot arm having more or fewer controllable axes.

On the rear side (which by way of example is provided to be orientated towards the machine tool), the handling apparatus 1 e.g. comprises a rear wall portion 9 and a positioning rod 12, which points e.g. horizontally rearwards and which facilitates the positioning at the machine tool. On the left-hand side, the handling apparatus 1 comprises e.g. a side wall portion 10, which is provided e.g. with an inspection window 11.

For example, a signal lamp 8 is provided on the side wall portion 10 and is designed to visually display an operating state of the handling apparatus 1, e.g. by light of different colors in order to characterize different operating states.

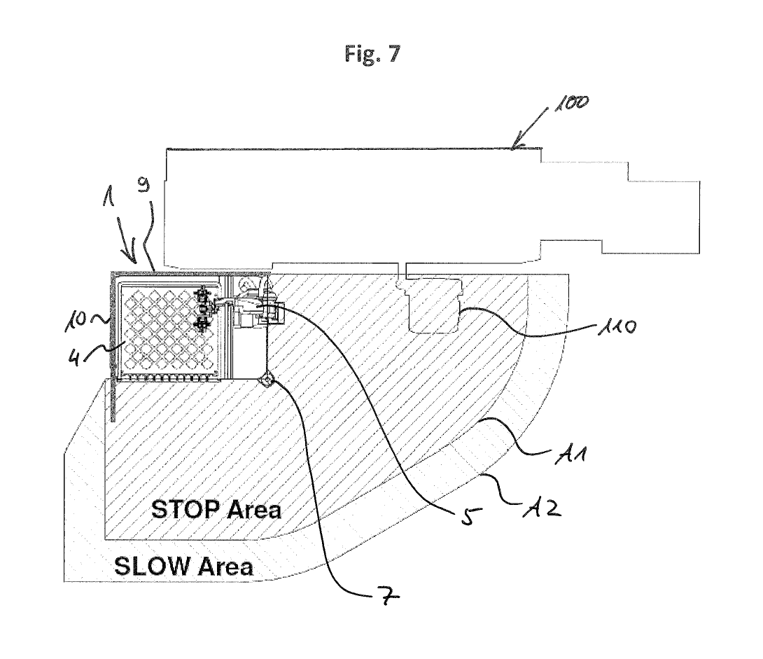

For example, the base body 5 has a sensor device 7 on the front right-hand corner portion, said sensor device being designed to detect a person (e.g. an operator) or an object in the vicinity of the handling apparatus 1, e.g. to stop or slow down the operation of the handling apparatus 1 when a person or an object is detected (see below e.g. the exemplary detection zones A1 and A2 according to FIG. 7 and the associated description). For this purpose, the sensor device 7 can have one or more motion detectors, one or more infrared sensors and/or one or more laser sensors or light barrier devices.

When the handling apparatus 1 is used e.g. at a lathe, the robot 5 can take workpieces from the holder plate 4 on the storage body 3 by means of the gripper device 6 and insert them into a workpiece spindle and/or a clamping chuck or a workpiece fixation of the machine tool and/or at the workpiece spindle and/or the clamping chuck or the workpiece fixation of the machine tool and place them at the holder plate 4 on the storage body 3.

When the handling apparatus 1 is used e.g. at a milling machine, the robot 5 can take tools from the holder plate 4 on the storage body 3 by means of the gripper device 6 and insert them into a tool spindle of the machine tool and/or receive them at the tool spindle of the machine tool and place them at the holder plate 4 on the storage body 3, or receive workpieces from the holder plate 4 on the storage body 3 and insert them into a workpiece clamp of the machine tool and/or receive them at the workpiece clamp of the machine tool and place them at the holder plate 4 on the storage body 3.

For this purpose, it is required for the handling apparatus 1 to adopt a reference position stored in the numeric control of the machine tool and/or the robot 5 in relation to the machine tool and/or to determine on the basis of the positioning of the handling apparatus 1 in relation to the machine tool the adopted reference position in an optionally manually controlled calibration process and to store it in the numeric control of the machine tool and/or the robot 5.

In order not to have to carry out this calibration process whenever the handling apparatus 1 is set up at a machine tool, the handling apparatus 1 comprises a self-centering positioning mechanism in such a way that the handling apparatus 1 adopts the once determined reference position in relation to the machine tool in a self-centering manner.

For this purpose, the handling apparatus 1 comprises in each case pairs of centering elements 14 and corresponding set-up elements 13 (i.e. a pair comprises a centering element 14 and a corresponding set-up element 13), the centering elements 14 being provided to be attached in a fixed positioning to the floor space in front of or next to the machine tool.

In this embodiment, the self-centering positioning mechanism is merely made by way of example with precisely three centering elements 14 and/or three corresponding set-up elements 13. The advantage is that an accurate three-point setup which always forms a plane can be provided.

However, in further embodiments it is possible to provide more or fewer centering elements 14 and/or corresponding set-up elements 13, it being possible to optionally provide one or more additional base elements, in particular in the case of less than three centering elements 14 and/or corresponding set-up elements 13.

FIG. 3 shows by way of example, a template for positioning centering elements in order to set up the handling apparatus according to FIG. 1. The template 15 has e.g. three openings 15a, 15b and 15c adapted to the shape of the centering elements 14, said openings predetermining the positioning of the e.g. three centering elements 14 in relation to one another, such that they adopt the predetermined position and orientation when they are attached to the floor space.

The centering elements 14 can be attached to the floor space e.g. by means of screws 16, bolts or other attachment elements. The use of the template 15 for the attachment of the centering elements 14 ensures in an easy way that the centering elements 14 can be attached in relation to one another in a simple and accurate way in the predetermined position and orientation.

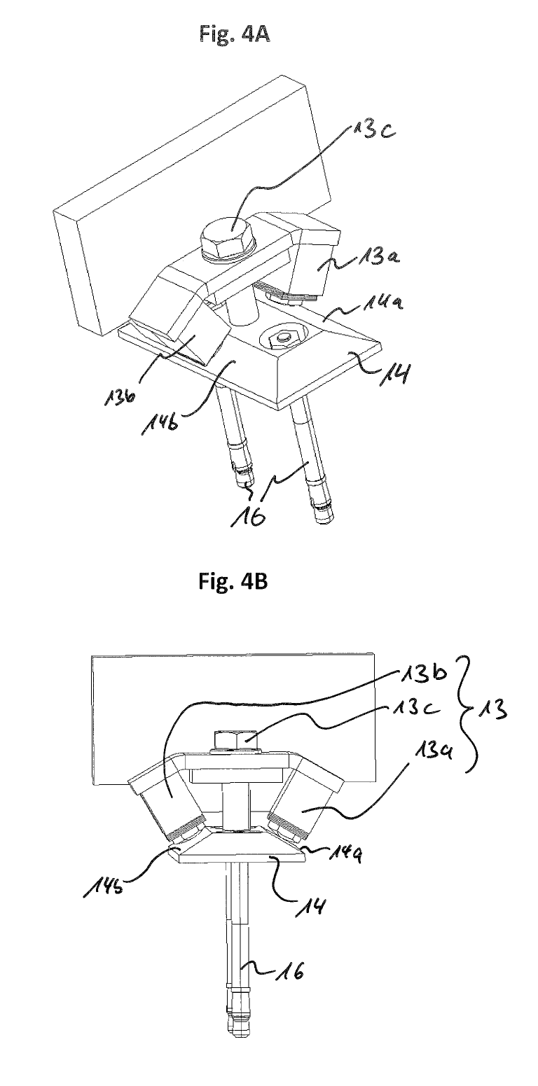

FIGS. 4A and 4B both show by way of example views of a pair of centering and set-up elements for setting up the handling apparatus according to FIG. 1.

For example, the centering elements 14 have a rectangular base and have a trapezoidal cross-section such that the centering elements 14 taper upwards and have respectively opposite inclined areas 14a and 14b.

The set-up elements 13 have e.g. rest elements 13a and 13b which are inclined in relation to one another and each of which rests on the inclined areas 14a and 14b of the centering elements 14 when the set-up elements 13 interact in each case in pairs with the corresponding centering elements 14 and/or rest thereon. Furthermore, the set-up elements have e.g. another support element 13c between the support elements 13a and 13b. For example, the support elements 13a, 13b and 13c all have height-adjustable screws for the fine adjustment.

The set-up elements 13 and centering elements 14, shown in FIGS. 4A and 4B, are merely exemplary and can also be made differently. In basic principle, either the set-up element 13 or the centering element 14 of a respective pair has the centering portion which tapers towards the other element (here by way of example the support surfaces of 14a and 14b), the respective other element of a pair of set-up and centering elements then having a receiving portion (here e.g. the rest surfaces of elements 13a to 13c) for the self-centering support of the tapering centering portion when the set-up element 13 is attached to the corresponding centering element 14.

Self-centering here means that a positioning of the set-up element 13 is determined in a positive engagement in at least one direction or in several directions in the case of a set-up element 13 attached to a centering element 14 such that in a state in which all or a plurality of set-up elements 13 are attached to the respective appropriate centering elements 14, the positioning of the base body 2 in relation to the floor space on which the centering elements 14 are mounted is determined in a horizontal plane and vertically downwards. The same applies analogously to the set-up and centering elements between the base body 2 and the storage body 3.

Due to the set-up elements 13 and centering elements 14, which in each case are arranged in pairs, it is easily possible to set up the base body 2 of the handling apparatus 1 in an easy way by positioning the set-up elements 13 above the respective corresponding centering elements 14 and then attaching them thereto, e.g. when the base body 2 is moved to the machine tool by means of a fork-lift truck and is then attached above the centering elements 14 fixed to the floor.

Due to this, the handling apparatus 1 can be employed in a mobile way and for use at a plurality of machine tools and, when moved to one of the machine tools, can be set up thereat in an easily and accurately self-centering way, thus adopting the same reference position in relation to the machine tool. The handling apparatus 1 can thus be used in an easy and efficient way, and the requirement of redetermining the reference position in relation to the machine tool by calibration is in particular omitted.

As an alternative, the handling apparatus 1 can easily recognize and/or identify, by means of a plug connection to the machine tool, e.g. to the energy supply of the handling apparatus 1 and/or to the communication connection to the numeric control and/or a control computer and/or control panel of the machine tool, which handling machine (among a group of machine tools) is provided with the handling apparatus 1 and to determine the previously determined or previously stored reference position on the basis of the recognized and/or identified machine tool.

Alternatively, the reference position can be previously stored in the numeric control and/or the control computer and/or control panel of the machine tool and can be transferred to the handling apparatus 1 when a connection to the machine tool is established. In addition to a communication via a plug connection, it is also possible to provide a wireless communication between machine tool and handling apparatus 1 (e.g. by means of BlueTooth, WLAN, etc.).

Here, the installing process including calibration and determination of the reference position of the handling apparatus 1 in relation to the corresponding machine tool can advantageously be carried out only once and, when the handling apparatus 1 is again moved to the machine tool and placed on the previously installed centering elements 14, the previously stored reference position can be adopted again without recalibration.

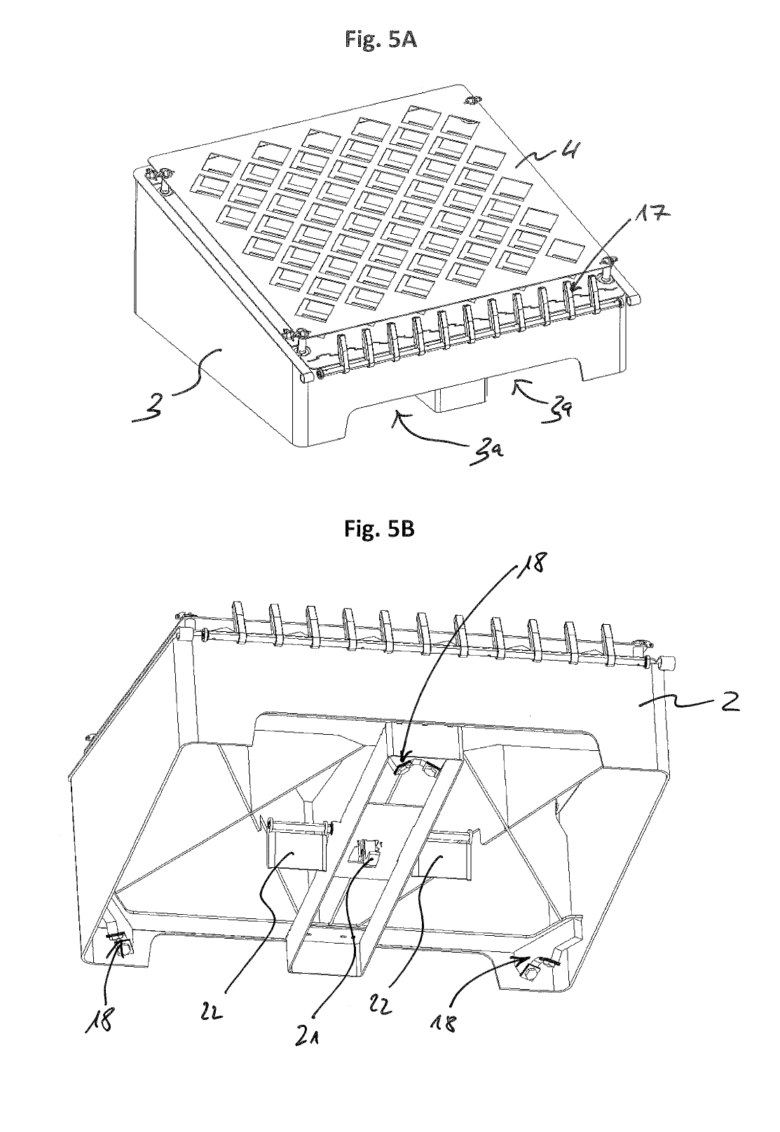

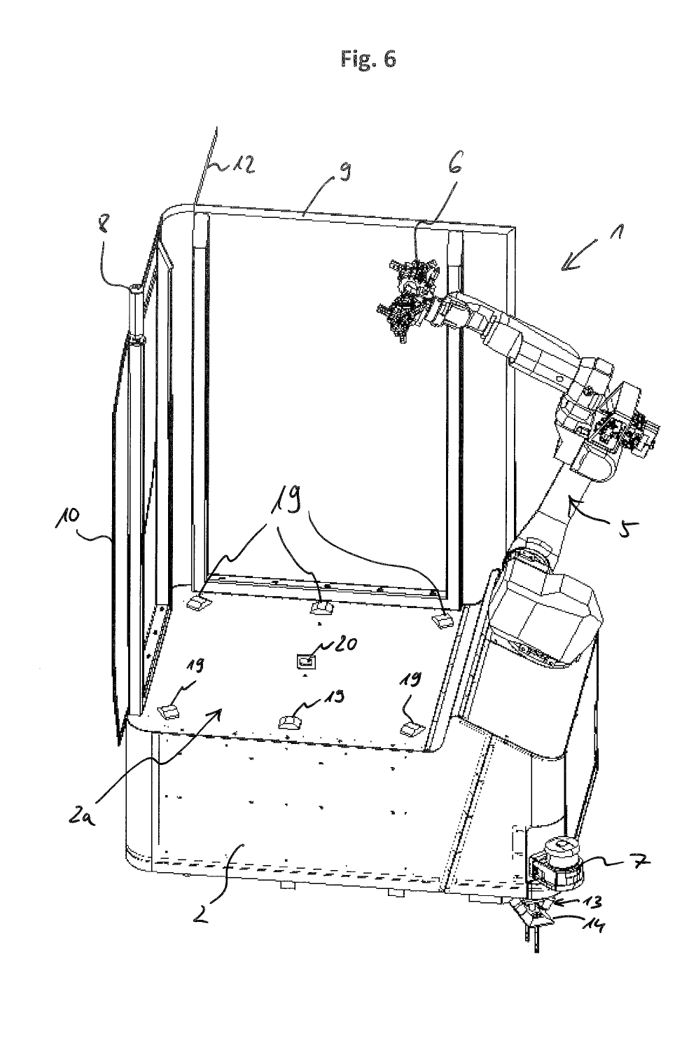

FIGS. 5A and 5B both show by way of example views of the storage body 3 of the handling apparatus according to FIG. 1. As already described, the storage body 3 carries e.g. a holder plate 4 having a plurality of supports and/or openings for receiving and/or storing tools and/or workpieces. FIG. 6 shows an exemplary perspective view of the handling apparatus according to FIG. 1 wherein the storage body is removed.

The storage body 3 can favorably be set up on the top side 2a of the handling apparatus 1 and can easily be taken up and lifted by a fork-lift truck. For this purpose, the storage body 3 has e.g. two receiving portions 3a for fork arms of a fork-lift truck. Due to this it is possible in an easy and efficient way to exchange or remove or attach storage bodies 3 on the handling apparatus 1 without moving the entire handling apparatus 1. The manual equipment of the holder plate can favorably be carried out offside the handling apparatus 1 without stopping the operation of the handling apparatus 1 (i.e. the set-up time parallel to the production time is rendered possible in an easy and efficient way).

In addition, the receiving portions 3a have e.g. flap portions 22 on the bottom side 22 of the storage body 3 such that the flap potions 22 are moved when fork arms of a fork-lift truck travel thereinto to unlock a locking element 21 coupled to the flap portions 22 from a locked state with a locking element 20 arranged on the top side 2a of the base body 2 and/or to lock it again when the fork arms leave the receiving portions 3a.

In order to ensure an accurate and simple positioning and to avoid that when a storage body 3 is exchanged the reference positioning and/or calibration of the handling apparatus 1 has to be carried out again, the bottom side of the storage body 3 also has set-up elements 18 which interact in pairs (in analogy to the set-up and centering element pairs 13 and 14) with corresponding centering elements 19 which are arranged on the top side 2a of the base body 2.

For this purpose, the handling apparatus 1 comprises in each case pairs of centering elements 19 arranged on the top side 2a of the base body 2 and set-up elements 18 arranged on the bottom side of the storage body 3. In this embodiment, the self-centering positioning mechanism is made with precisely three corresponding set-up elements 18. The advantage is that an accurate three-point setup always forming a plane can be provided. However, in further embodiments it is possible to also provide more or less than three set-up elements 18, it being possible to optionally provide one or more additional base elements, in particular in the case of less than three set-up elements 18.

For example, six centering elements 19 are arranged on the top side 2a of the base body 2 of the handling apparatus 1, and therefore the storage body 3 can be attached to two positions on the base body 2 (once to a first group of three of the six centering elements 19 and once to the other three centering elements 19).

In basic principle, either the set-up element 18 or the centering element 19 has a centering portion which tapers towards the other element, the respective other element of a pair of set-up and centering elements then having a receiving portion for the self-centering support of the centering portion when the set-up element 18 is attached to the corresponding centering element 19.

Self-centering here means that a positioning of the set-up element 18 is determined in the case of a set-up element 18 attached to a centering element 19 in at least one direction or in a plurality of directions in positive engagement in such a way that in a state in which all or a plurality of set-up elements 18 are attached to the respective corresponding centering elements 19, the positioning of the storage body 3 is determined in relation to the base body 2 in a horizontal plane and vertically downwards in positive engagement.

Due to the set-up elements 18 and centering elements 19 provided in pairs it is easily possible to simply attach the storage body 3 to the handling apparatus 1 by positioning the set-up elements 18 above the respective corresponding centering elements 19 and then place them thereon, e.g. when the storage body 3 is moved to the handling apparatus 1 by means of a fork-lift truck and then attached above the centering elements 19 arranged on the top side 2a of the base body 2.

By way of example, the storage body 3 additionally has for each row of supports of the holding plate 4 a respective foldable pin element 17, which can be folded down to signal that all workpieces received in this row by supports have already been machined. It is thus possible for an operator to see from a distance how many workpieces have already been machined and/or when the storage body 3 has to be reloaded.

FIG. 7 shows an exemplary top view of the handling apparatus 1 according to FIG. 1 at a machine tool 100. The handling apparatus 1 is positioned in front of the machine tool 100. This FIG. 7 shows that the sensor device 7 monitors two zones in front of the machine tool 100 and next to the handling apparatus 1, namely an inner zone A1 (first area) and an outer zone A2 (second area).

When the sensor device 7 detects that a person (e.g. an operator) enters the outer zone A2 or an object travels or is moved into this zone A2, the operation of the handling apparatus 1 is slowed down for reasons of safety and when the sensor device 7 detects that a person enters the inner zone A1 or an object travels or is moved into this zone A1, the operation of the handling apparatus 1 is stopped and/or the robot 5 is stopped for reasons of safety.

The inner zone A1 also comprises e.g. the area where the control panel 110 of the machine tool is arranged.

In particularly useful embodiments, the handling apparatus 1 does not comprise an operation or control apparatus of its own but can be controlled and installed via the control of the machine tool by means of the control panel 110 of the machine tool 100. For example, the handling apparatus 1 can advantageously be designed in such a way that the installation and/or calibration process of the handling apparatus 1 is controlled via the control panel 110 of the machine tool 100.

The programming of the handling operations and/or the installation of the operation can also be preferably controlled via the control panel 110 of the machine tool 100. For this purpose, the operator can input information required at the control panel 110 of the machine tool 100 at the control device, such as designations of the workpieces and/or tools supported on the handling apparatus 1, the dimensions of the workpieces (e.g. prior to the machining operation by inputting the blank dimensions and/or after the machining operation by inputting the finished part dimensions, i.e. e.g. blank data and/or finished part data, optionally with workpiece lengths and workpiece diameters) and/or tools, indication of the rests and/or supports which are employed or are to be employed on the holder plate 4, indication of the dimensions of clamping chucks and/or transfer positions, indication of functions to be carried out and/or indication of the dimensions of the grippers of the gripper device 6, etc.

For this purpose, the operating interface of the control panel 110 of the machine tool can comprise a computer program, e.g. having a corresponding graphical user interface (e.g. in the form of an APP of the user interface of the control software of the machine tool), which renders possible the steps of installing the handling apparatus 1 and in particular the input of the above mentioned data at the control panel 110 of the machine tool.

In the above described embodiments, the handling apparatus 1 can also be controlled and/or installed via the control panel and/or the control of the machine tool when the handling apparatus 1 is connected to the machine tool via a communication connection. Here, the handling apparatus 1 (e.g. the base body 2) can preferably be provided with at least one emergency shutdown in order to stop the operation of the handling apparatus 1. In further embodiments it is also possible to provide the handling apparatus 1 with an independent and/or separate control and/or operating apparatus in order to operate, control and/or install the handling apparatus 1.

Examples and embodiments of the present invention and the advantages thereof are described in detail above with reference to the enclosed drawings. However, it is pointed out again that the present invention is by no means limited and/or restricted to the above described embodiments and the implementation features thereof but comprises further modifications of the embodiments, in particular those that are comprised by modifications of the features of the described examples and/or by combination of individual or a plurality of the features of the described examples on the basis of the scope of protection of the independent claims.

In summary, a handling apparatus can be provided for use on a machine tool which can be used, as required, universally and efficiently with a small space requirement and preferably in mobile fashion at a plurality of machine tools and can be installed in an easy way.

1. A handling apparatus for use at a machine tool, comprising:
a base body (2), which can be set up on a floor space,
a storage body (3) which can be set up on the top side of the base body (2) and serves for storing a plurality of workpieces or tools, and
a handling robot (5), which is arranged on the base body (2) and has a gripper device (6) for taking a workpiece and/or tool from the storage body (3) and for inserting the workpiece and/or tool taken from the storage body (3) by the gripper device (6) into a corresponding workpiece and/or tool support of the machine tool (100),
wherein a plurality of first set-up elements (18) are arranged on the bottom side of the storage body (3) and a plurality of first centering elements (19) are arranged on the top side (2a) of the base body (2), and
wherein, when the storage body (3) is set up on the top side (2a) of the base body (2), the first set-up elements (18) interact in each case in pairs and in self-centering manner with the first centering elements (19) in such a way that the storage body (3) adopts a predetermined reference position in relation to the base body (2).

2. The handling apparatus according to claim 1, wherein three first set-up elements (18) are arranged on the bottom side of the storage body (3) in order to provide a three-point setup.

3. The handling apparatus according to claim 2, wherein three first centering elements (19) are arranged on the top side of the base body (2) in order to provide a three-point setup.

4. The handling apparatus according to claim 2, wherein three first centering elements (19) are arranged on the top side of the base body (2) in order to provide a three-point setup of the storage body (3) in a first position, and three further first centering elements (19) are arranged on the top side of the base body (2) in order to provide a three-point setup of the storage body (3) in a second position.

5. The handling apparatus according to claim 1, wherein the storage body (3) has two receiving portions (3a) for fork arms of a fork-lift truck in order to take and lift the storage body (3) from the base body (2) by means of a fork-lift truck.

6. The handling apparatus according to claim 5, wherein the storage body (3) comprises a locking mechanism having a locking element (21), which can be interlocked with a locking element (20) arranged on the top side (2a) of the base body (2).

7. The handling apparatus according to claim 6, wherein the locking mechanism is designed to unlock the locking element (21) of the locking mechanism when fork arms of a fork-lift truck enter into the receiving portions (3a) of a storage body (3) for fork arms.

8. The handling apparatus according to claim 1, wherein the storage body (3) carries a holding plate (4) which has a plurality of receiving openings for tools and/or workpieces.

9. The handling apparatus according to claim 1, wherein the handling robot (5) has six controllable rotation axes and/or the gripper device (6) of the handling robot (5) has a double gripper.

10. The handling apparatus according to claim 1, wherein a plurality of second set-up elements (13) are arranged on the bottom side of the base body (2) and, in the case of a base body (2) placed on the floor space, when a plurality of second centering elements (14) are arranged on the floor space, are designed to interact in each case in pairs and in self-centering manner with the second centering elements (14) in such a way that the base body (2) adopts a predetermined reference position in relation to the floor space and/or in relation to the machine tool (100) placed on the floor space.

11. The handling apparatus according to claim 10, wherein three second set-up elements (13) are arranged on the bottom side of the base body (2) in order to provide a three-point setup.

12. The handling apparatus according to claim 1, further comprising by a sensor device (7) for detecting a person or an object in an area adjacent to the handling apparatus (1).

13. The handling apparatus according to claim 12, wherein the handling apparatus (1) is designed to stop the operation when the sensor device (7) detects a person or an object in a first area (A1) and/or the handling apparatus (1) is designed to switch into a decelerated operation when the sensor device (7) detects a person or an object in a second area (A2).

14. The handling apparatus according to claim 1, wherein the handling apparatus (1) can be connected and/or coupled to the machine tool (100) and/or a control device of the machine tool via a wireless connection or cable plug connection.

15. The handling apparatus according to claim 14, wherein the handling apparatus (1) is designed to identify the connected machine tool among a group of machine tools via the communication connection.

16. The handling apparatus according to claim 15, wherein the handling apparatus (1) is designed to determine a previously stored reference position depending on the identified machine tool.

17. The handling apparatus according to claim 14, wherein the handling apparatus (1) is designed to be controlled and/or installed via a control panel (110) of the connected machine tool.
